(19) United States
(12) Patent Application Publication
(10) Pub. No.: US 2019/0318863 A1
(43) Pub. Date: Oct. 17, 2019

(54) COIL COMPONENT AND INDUCTOR

(71) Applicant: KYOCERA Corporation, Kyoto-shi, Kyoto (JP)

(72) Inventors: Takanori KONISHI, Yasu-shi, Shiga (JP); Hiroshi HAMASHIMA, Hikone-shi, Shiga (JP)

(21) Appl. No.: 16/315,628

(22) PCT Filed: Jul. 5, 2017
(86) PCT No.: PCT/JP2017/024706

§ 371 Date: Jan. 4, 2019

(30) Foreign Application Priority Data
Jul. 5, 2016 (JP) 2016-133634

(51) Int. Cl. H01F 27/26; H01F 27/28; H01F 41/02

(52) U.S. Cl. CPC H01F 27/263; H01F 41/0206; H01F 27/2823

(57) ABSTRACT

There is provided a coil component which includes a core; and a plurality of leg portions provided at respective ends of the core, wherein each of the leg portions includes a protrusion which protrudes inward with respect to a joint between the core and the leg portion.

### TECHNICAL FIELD

The present disclosure relates to a coil component and an inductor.

### BACKGROUND ART

In various kinds of electronic devices, many electronic components such as a capacitor, a chip resistor, and an inductor are mounted. Along with advance in miniaturization of a portable electronic device, also advance in miniaturization in those electronic components is being made. In many cases with those electronic components, an electrode of an electronic component is bonded to an electrode of a mounting body such as a printed wiring board. For such bonding to a mounting body, solder or the like is used for example.

Patent Document 1, for example, discloses one example of an inductor. An inductor includes a coil component which includes a core around which a conducting wire is to be wound and leg portions provided at respective ends of the core. The inductor in Patent Document 1 is configured in such a manner that a conducting wire is wound around the core of the coil component.

### RELATED ART DOCUMENT

### Patent Document

Patent Document 1: Japanese Unexamined Patent Publication No. 10-135048

### SUMMARY OF THE INVENTION

A coil component according to the present disclosure is a coil component including a core and a plurality of leg portions provided at respective ends of the core, and each of the leg portions includes a protrusion which protrudes inward with respect to a joint between the core and the leg portion. The inductor according to the present disclosure includes the above-described coil component, a conducting wire wound around the core, and an electrode layer provided in each of the leg portions.

### BRIEF DESCRIPTION OF THE DRAWINGS

FIG. 1A is a perspective view of one embodiment of an inductor.

FIG. 1B is a partial sectional view of the one embodiment of the inductor.

FIG. 1C is a partial sectional view of the one embodiment of the inductor.

FIG. 2 is a partial sectional view showing an example of a state in which the one embodiment of the inductor is mounted.

FIG. 3A is a perspective view of a different embodiment of an inductor.

FIG. 3B is a partial sectional view of the different embodiment of the inductor.

FIG. 3C is a partial sectional view of the different embodiment of the inductor.

FIG. 4 is a partial sectional view showing an example of a state in which the different embodiment of the inductor is mounted.

### EMBODIMENTS FOR CARRYING OUT THE INVENTION

Some embodiments of a coil component and an inductor will be described in detail with reference to the drawings. In all of the drawings in the present specification, the same reference numerals are given to members having similar configurations and description thereof is omitted as appropriate unless confusion arises. It is noted that the drawings provide schematic representation, and dimensions, positional relationships, and the like of various kinds of structures in the drawings are not necessarily shown exactly.

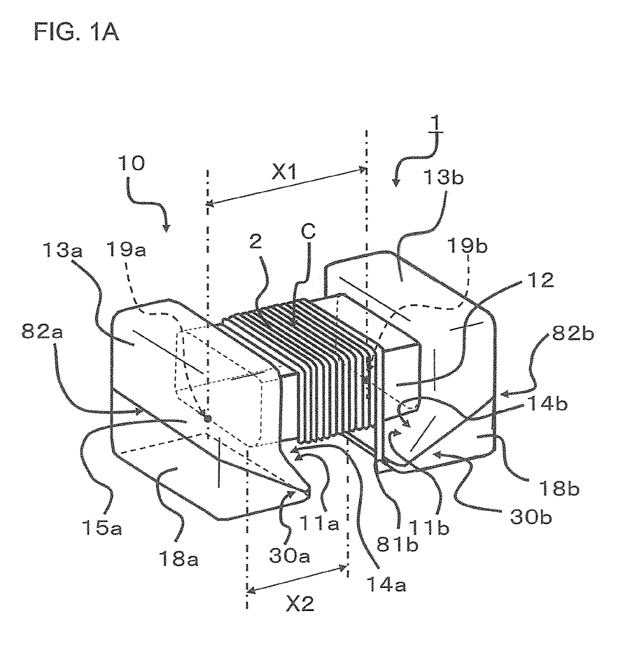

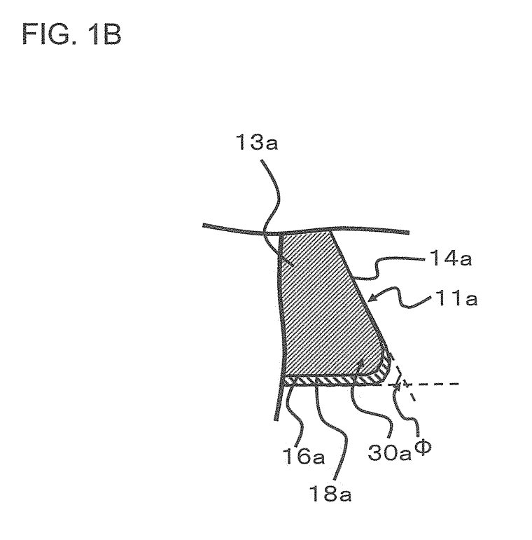

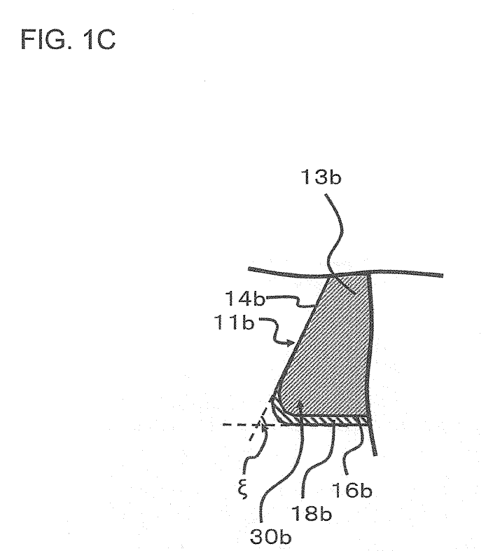

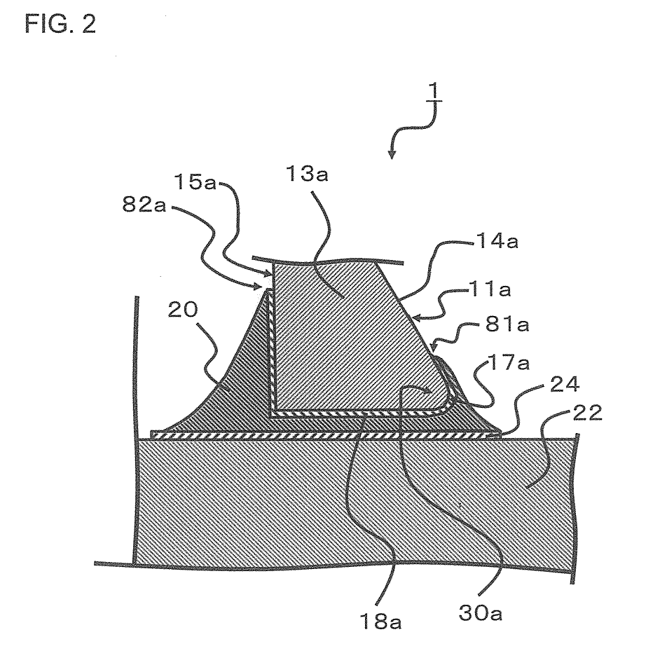

FIG. 1 shows one embodiment of an inductor. FIG. 1(a) is a perspective view, FIG. 1(b) is an enlarged sectional view of a part of a left leg portion in FIG. 1(a), and FIG. 1(c) is an enlarged sectional view of a part of a left leg portion in FIG. 1(a). Also, FIG. 2 is an enlarged sectional view of principal parts in a state in which an inductor shown in FIG. 1 is mounted.

A coil component 10 forming an inductor 1 shown in FIG. 1 includes a core 12 and a plurality of leg portions (a leg portion 13a and a leg portion 13b in the present embodiment) which are provided at respective ends of the core 12. The leg portion 13a includes a protrusion 30a which protrudes inward with respect to a joint 19a between the core 12 and the leg portion 13a. Also, the leg portion 13b includes a protrusion 30b which protrudes inward with respect to a joint 19b between the core 12 and the leg portion 13b.

The coil component 10 shown in FIG. 1 is a component in a form of a so-called drum core. The inductor 1 includes a conducting wire 2 wound around the core 12, an electrode layer 18a provided in an end surface 16a, and an electrode layer 18b provided in an end surface 16b. The leg portion 13a includes the protrusion 30a which protrudes over a vertical line of the joint 19a between the core 12 and the leg portion 13a. Also, the leg portion 13b includes the protrusion 30b which protrudes over a vertical line of the joint 19b between the core 12 and the leg portion 13b. It is noted that the coil component 10 will be discussed as a main subject in the following description except portions dealing with an overall configuration, bonding to a mounted body, and the like.

The leg portion 13a includes an inner surface 14a, the leg portion 13b includes an inner surface 14b, and the inner surface 14a and the inner surface 14b face each other. The leg portion 13a includes an outer surface 15a opposite to the inner surface 14a, and the leg portion 13b includes an outer surface 15b opposite to the inner surface 14b.

The inner surface 14a includes an inclined surface 11a in a region corresponding to the protrusion 30a, and the inner surface 14b includes an inclined surface 11b in a region corresponding to the protrusion 30b. The leg portion 13a includes the end surface 16a which is shown as a lower surface in the drawing. The end surface 16a is continuous with the protrusion 30a. The leg portion 13b includes the end surface 16b which is shown as a lower surface in the drawing. The end surface 16b is continuous with the protrusion 30b. In the end surface 16a, the electrode layer 18a including a plating layer, for example, is provided. In the end surface 16b, the electrode layer 18b which includes a plating layer, for example, is provided.

In an example shown in FIG. 1, each of the end surface 16a and the end surface 16b is parallel to a lengthwise direction of the core 12. A vertical line of the joint 19a between the core 12 and the leg portion 13a is orthogonal to the end surface 16a. Also, a vertical line of the joint 19b between the core 12 and the leg portion 13b is orthogonal to the end surface 16b. The joint 19a is a portion where the inner surface 14a and the core 12 are in contact with each other, and the joint 19b is a portion where the inner surface 14b and the core 12 are in contact with each other. A length of the core 12 corresponds to a length between the joint 19a and the joint 19b.

The inclined surface 11a is inclined in such a manner that a distance to the end surface 16b of the leg portion 13b from the inclined surface 11a decreases as a distance to the end surface 16a from the core 12 decreases. The inclined surface 11b is inclined in such a manner that a distance to the end surface 16a of the leg portion 13a from the inclined surface 11b decreases as a distance to the end surface 16b from the core 12 decreases. Accordingly, in the coil component 10, a length X2 between the end surface 16a and the end surface 16b is smaller than a length of the core 12, the length being denoted by “X1” in FIG. 1.

The coil component 10 is a so-called 0402-size electronic component in which a length along a direction from the leg portion 13a toward the leg portion 13b is approximately 0.4 mm, and a length (height) along a direction from the end surface 16a toward a surface opposite to the end surface 16a is approximately 0.2 mm, for example. As a size and a form of the coil component 10 are not limited to any specific ones, a so-called 0603-size (0.6 mm long and 0.3 mm high) electronic component can be used and a form thereof is not limited to a form of a drum core.

FIG. 2 is an enlarged sectional view of principal parts in a state in which the inductor shown in FIG. 1 is mounted. As shown in FIG. 2, the inductor 1 is mounted in a mounted body 22 such as a printed wiring board, for example. The inductor 1 is bonded to a conductor layer 24 such as an electrode pad which is provided in a surface of the mounted body 22 and includes gold (Au) as a main ingredient, for example, via a bonding member 20 such as solder. It is noted that though only a side where the leg portion 13a is provided is selectively shown in FIG. 2, a side where the leg portion 13b is provided has a similar configuration. Hereinafter, only a side where the leg portion 13a is provided will be described as a representative.

The electrode layer 18a in the leg portion 13a is bonded to the conductor layer 24 of the mounted body 22 via the bonding member 20 such as solder. In a process for the bonding, molten metal such as reflowed solder, for example, easily wets, and spreads over, a whole of the electrode layer 18a having relatively good wettability. For example, in a case where molten metal wets and spreads over, the electrode layer 18a to such a degree that the molten metal lies off the electrode layer 18a, the bonding member 20 is electrically connected with the conducting wire 2 located in the core 12, so that an inductor function may be impaired in some cases. The leg portion 13a includes the inclined surface 11a in a region corresponding to the protrusion 30a, and the inclined surface 11a can suppress wetting up of molten metal, so that impairment of an inductor function can be suppressed.

Also, in the coil component 10, the leg portion 13a includes the protrusion 30a, and a cross-sectional area of the leg portion 13a at the protrusion 30a is relatively large. Accordingly, an area of the end surface 16a of the leg portion 13a is relatively large, so that an area of the electrode layer 18a is relatively large. As a result of this, an area where the electrode layer 18a and the conductor layer 24 of the mounted body 22 are bonded to each other is relatively large, so that bonding strength between the inductor 1 and the mounted body 22 is relatively high.

The electrode layer 18a includes an inner end line 81a located in the inner surface 14a of the leg portion 13a, and an outer end line 82a located in the outer surface 15a. A distance from the end surface 16a to the inner end line 81a may be smaller than a distance from the end surface 16a to the outer end line 82a. In such a case, it is possible to secure a large bonding area for the electrode layer 18a and the bonding member 20 and make bonding strength relatively high in the end line 82a which is located farther from the conducting wire 2, without impairing an inductor function, so that increased reliability can be attained.

In the coil component 10, each of an angle ϕ which is formed between the end surface 16a and the inclined surface 11a in the leg portion 13a as shown in FIG. 1(b) and an angle ξ which is formed between the end surface 16b and the inclined surface 11b in the leg portion 13b as shown in FIG. 1(c) may be equal to or larger than 70 degrees and equal to or smaller than 80 degrees. In this case, wetting up of molten metal such as reflowed solder can be suppressed. Also in this case, concentration of stress around the joint 19a and the joint 19b can be relieved. The angle and the angle can be measured using observed images which are obtained by observation of sections shown in FIGS. 1 (b) and 1(c). More specifically, an angle between a virtual line along the end surface 16a and a virtual line along the inclined surface 11a can be measured. It is noted that in a case where it is difficult to cut the coil component 10 or a like case, a three-dimensional shape of the coil component 10 is measured, and an angle between a virtual line along the inclined surface 11a and a virtual line along the end surface 16a can be measured based on data of the measured three-dimensional shape.

Also, in the coil component 10, an intersecting portion 17a of the inclined surface 11a and the end surface 16a may be a curved surface. In this case, a creepage distance from the end surface 16a to the end line 81a is lengthened, so that bonding strength is enhanced. Also, by inclusion of the intersecting portion 17a, concentration of an electric field in the leg portion 13a can be relieved. A radius of curvature of the intersecting portion 17a is equal to or smaller than approximately 0.025 mm, for example. Also, stress is more likely to be concentrated in the intersecting portion 17a of the inclined surface 11a and the end surface 16a in a bonded state. In the inductor 1, since the intersecting portion 17a is a curved surface, concentration of stress applied to the intersecting portion 17a is relieved, so that mechanical breakage or fracture of the coil component 10 is suppressed.

The core 12, the leg portion 13a, and the leg portion 13b include ceramic which contains an aluminum oxide or ferrite as a main ingredient, for example. A main ingredient in ceramic means an ingredient occupying 70% by mass or higher in 100% by mass of ingredients forming ceramic, and particularly, it is preferable that a main ingredient occupies 80% by mass or higher. For identification of an ingredient (crystal structure) forming ceramic, an X-ray diffraction instrument can be used. Also, a content can be determined in terms of an oxide based on an identified crystal structure after determination of a content of a metallic element using an inductively coupled plasma (ICP) emission spectrometer or an X-ray fluorescence analyzer.

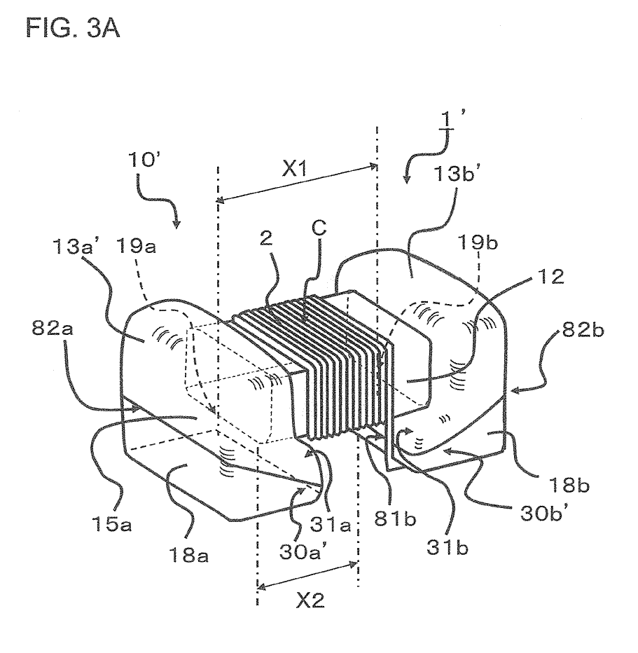

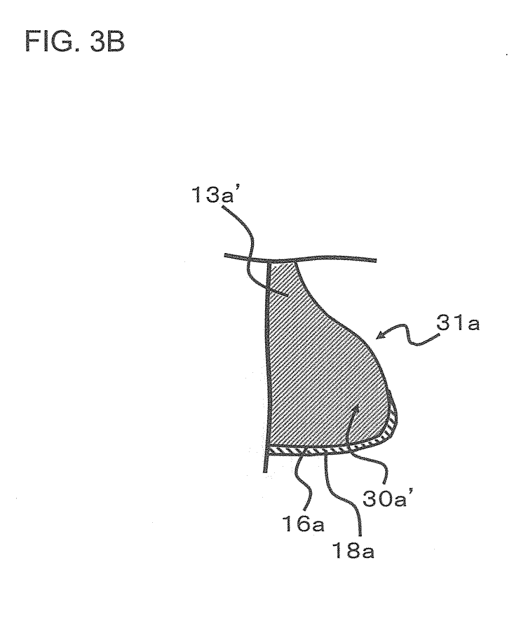

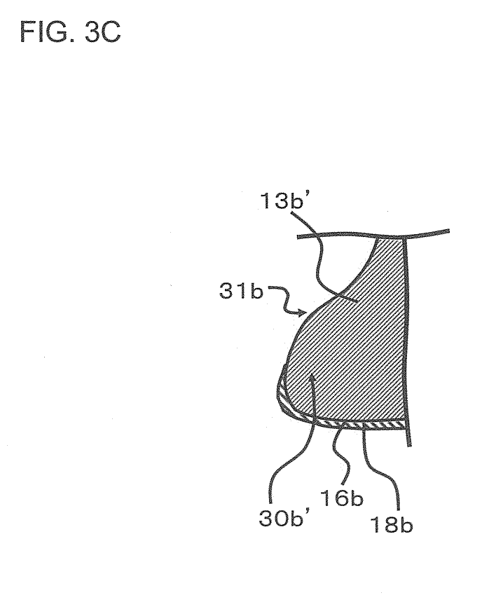

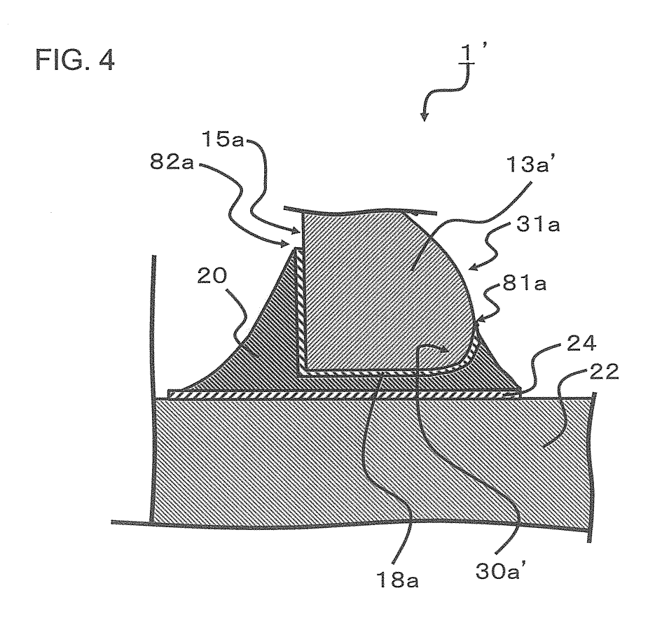

FIG. 3 shows a different embodiment of an inductor. FIG. 3 (a) is a perspective view, FIG. 3 (b) is an enlarged sectional view of a part of a left leg portion in FIG. 3 (a), and FIG. 3(c) is an enlarged sectional view of a part of a right leg portion in FIG. 3 (a). Also, FIG. 4 is an enlarged sectional view of principal parts in a state where an inductor shown in FIG. 3 is mounted. In FIGS. 3 and 4, components similar to those in FIGS. 1 and 2 are shown with the use of the same reference numerals as those in FIGS. 1 and 2. It is noted that a coil component 10′ will be discussed as a main subject also in the following description except portions dealing with an overall configuration and bonding to a mounted body.

The coil component 10′ shown in FIG. 3 is different from the coil component 10 shown in FIGS. 1 to 2 in that each of a protrusion 30a′ in a leg portion 13a′ and a protrusion 30b′ in a leg portion 13b′ has a shape of rounded protrusion as a whole. The leg portion 13a′ includes the protrusion 30a′ which protrudes inward with respect to a joint 19a′ between a core 12 and the leg portion 13a′. Also, the leg portion 13b′ includes the protrusion 30b′ which protrudes inward with respect to a joint 19b′ between the core 12 and the leg portion 13b′. In the coil component 10′, the protrusion 30a′ includes a convexly-curved surface 31a, and the protrusion 30b′ includes a convexly-curved surface 31b.

FIG. 4 is an enlarged sectional view of principal parts in a state in which an inductor 1′ shown in FIG. 3 is mounted. Also in an example shown in FIG. 4, the inductor 1′ is bonded to a conductor layer 24 such as an electrode pad which is provided in a mounted body 22 such as a printed wiring board and includes gold (Au) as a main ingredient, for example, via a bonding member 20 such as solder, to be used.

The inductor 1′ is bonded to the conductor layer 24 such as an electrode pad which is provided in a surface of the mounted body 22 and includes gold (Au) as a main ingredient, for example, via the bonding member 20 such as solder. It is noted that though only a side where the leg portion 13a′ is provided is selectively shown in FIG. 4, a side where the leg portion 13b′ is provided has a similar configuration. Hereinafter, only a side where the leg portion 13a′ is provided will be described as a representative. An electrode layer 18a in the leg portion 13a′ is bonded to the conductor layer 24 of the mounted body 22 via the bonding member 20 such as solder. In a process for the bonding, molten metal such as reflowed solder, for example, easily wets, and spreads over, a whole of the electrode layer 18a having relatively good wettability.

The leg portion 13a′ in the coil component 10′ includes the convexly-curved surface 31a, and wetting up of molten metal at a time of bonding is more surely suppressed, so that a possibility of impairment of an inductor function is reduced.

Further, in the coil component 10′, a cross-sectional area of the leg portion 13a′ at a portion corresponding to the convexly-curved surface 31a is increased. Also an area of the end surface 16a of the leg portion 13a′ is increased, so that an area of the electrode layer 18a is increased. Accordingly, an area where the electrode layer 18a and the conductor layer 24 of the mounted body 22 are bonded to each other is increased, so that bonding strength between the inductor 1′ and the mounted body 22 is enhanced.

Further, in the coil component 10′, the convexly-curved surface 31a may be continuous with the end surface 16a. Since the coil component 10′ includes the convexly-curved surface 31a, a creepage distance from the end surface 16a to an end line 81a is relatively long, so that bonding strength is relatively high. Also, in a case where the convexly-curved surface 31a has a shape of a curved surface which is rounded as a whole or in a like case, portions in which an electric field is likely to be concentrated, such as an edged portion or a protrusion, are relatively small in number, so that concentration of an electric field in the leg portion 13a′ is relieved. Likewise, in a case where the convexly-curved surface 31a has a shape of a curved surface which is rounded as a whole, portions in which stress is likely to be concentrated are small in number, so that mechanical breakage or fracture of the coil component 10′ can be suppressed.

Next, an embodiment of a method for manufacturing a coil component and an inductor will be described. Firstly, description will be made with regard to a case where a coil component includes ceramic which contains an aluminum oxide as a main ingredient.

Firstly, aluminum oxide (Al₂O₃) powder, silicon oxide (SiO₂) powder as a Si source, calcium carbonate (CaCO₃) powder as a Ca source, and magnesium hydroxide (Mg(OH)₂) powder as an Mg source, are prepared. In this regard, those powders are weighed in such a manner that a content of Al in terms of Al₂O₃ amounts to 99.4% by mass or higher in 100% by mass of ingredients which form a coil component.

Then, aluminum oxide powder, silicon oxide powder, calcium carbonate powder, and magnesium hydroxide powder which amount to 100 parts by mass in total are mixed with 1 to 1.5 parts by mass of a binder such as polyvinyl alcohol (PVA), 100 parts by mass of a solvent, and 0.1 to 0.55 parts by mass of a disperser, so that a slurry is obtained.

Subsequently, after a slurry is subjected to spray drying and granules are obtained, the obtained granules are charged into a molding die and molded into a predetermined shape by a dry pressure forming process or the like. Then, a compact as obtained is maintained at a sintering temperature of 1450 to 1750° C. for two to five hours. After the above-described processes are performed, a coil component including ceramic which contains an aluminum oxide as a main ingredient can be obtained.

Next, description will be made with regard to a case where a coil component includes ceramic which contains ferrite as a main ingredient. Firstly, powder of each of oxides of Fe, Zn, Ni, and Cu, or powder of each metal salt such as carbonate, nitrate, and the like, from which oxides of Fe, Zn, Ni, and Cu are generated by sintering (such powder may be hereinafter also referred to as Fe source powder, Zn source powder, Ni source powder, and Cu source powder), is prepared. It is preferable that a mean particle size is in a range from 0.5 μm to 5 μm, inclusive, in a case where Fe is an iron oxide (Fe₂O₃), Zn is a zinc oxide (ZnO), Ni is a nickel oxide (NiO), and Cu is a copper oxide (CuO), for example.

Subsequently, for example, in a case where a composition range in 100 mole % of Fe, Zn, Ni, and Cu in terms of an oxide includes 49.5 mole % of Fe in terms of Fe₂O₃, 30.5 mole % of Zn in terms of ZnO, 12.5 mole % of Ni in terms of NiO, and 7.5 mole % of Cu in terms of CuO, Fe source powder, Zn source powder, Ni source powder and Cu source powder out of starting materials are weighed in such a manner that the above composition is attained, and are ground and mixed with one another with the use of a ball mill or the like. Then, calcination is conducted at a temperature of 700 to 1000° C. in the atmosphere, so that a calcined material is obtained.

Thereafter, the calcined material is put into a ball mill or the like together with water, and is ground and mixed with water. Then, a predetermined amount of binder or the like is added, so that a slurry is obtained. Subsequently, spray drying is conducted, so that granules are obtained. Then, the obtained granules are charged into a molding die, and a compact having a predetermined shape is obtained by a dry pressure forming process or the like. Subsequently, the compact is subjected to a degreasing process at a temperature of 400 to 800° C. in a degreasing furnace, to be converted into a degreased material, and thereafter, the degreased material is maintained at a sintering temperature of 1000 to 1200° C. for two to five hours. After the above-described processes are performed, a coil component including ceramic which contains ferrite as a main ingredient is obtained.

Next, a method for forming an electrode layer will be described. Firstly, a base layer is formed in an end surface of a leg portion of a coil component which is obtained by the above-described method. The base layer may be formed by application of paste which contains molybdenum as a main ingredient and also contains manganese and heat treatment at a temperature of 1400° C. in a reducing atmosphere, for example. After the base layer is formed, an electrode layer is formed on a surface of the base layer. The electrode layer may be formed by a barrel plating process, for example. The electrode layer contains nickel, gold, or tin, as a main ingredient, for example. Secondly, by winding a conducting wire around a core, it is possible to obtain an inductor.

In a manufacturing process such as a barrel plating process, in an inspecting process after manufacture, in the course of conveyance of completed products, or the like, for example, many coil components are collectively handled. For example, many coil components 10 are collectively put into a container for conveyance, and the container is conveyed. Within such a container, the plurality of coil components 10 are positioned randomly and collide with one another. In such a situation, the core 12 or the leg portion 13a of a certain coil component 10 is likely to enter between the leg portion 13a and the leg portion 13b of another coil component 10, and the certain coil component 10 may be sandwiched between the leg portion 13a and the leg portion 13b. When such sandwiching as described occurs, much time and much effort are expended in removing the sandwiched coil component, or if the sandwiched coil component cannot be released, there arises a need to dispose of the coil component as a defective in some cases. Amounts of time and effort associated with such sandwiching and a probability of occurrence of a defective increase as the coil component 10 becomes smaller. In contrast thereto, in the coil component 10 according to the present embodiments, the leg portion 13a includes the protrusion 30a and the leg portion 13b includes the protrusion 30b, so that a length between the leg portion 13a and the leg portion 13b is relatively small. Accordingly, the core 12, the leg portion 13a, or the like of a certain coil component 10 is unlikely to enter between the leg portion 13a and the leg portion 13b of another coil component 10. The coil component 10 according to the present embodiments suppresses sandwiching of a different coil component 10, so that much time and much effort which may be expended in the course of conveyance are saved, or occurrence of a defective resulted from sandwiching is suppressed, for example.

The present invention is not limited to the above-described embodiments, and various kinds of modifications, improvements, and the like are possible within the scope that does not depart from the essence of the present invention.

### DESCRIPTION OF THE REFERENCE NUMERAL

1: Inductor
2: Conducting wire
10: Coil component
11a, 11b: Inclined surface
12: Core
13a, 13b: Leg portion
14a, 14b: Inner surface
15a, 15b: Outer surface
16a, 16b: End surface
18a, 18b: Electrode layer
17a, 17b: Intersecting portion
30a, 30b: Protrusion
31a, 31b: Convexly-curved surface

1. A coil component comprising:
a core; and
a plurality of leg portions provided at respective ends of the core,
wherein each of the leg portions includes a protrusion that protrudes inward with respect to a joint between the core and the leg portion.

2. The coil component according to claim 1, wherein
the protrusion includes an inclined surface.

3. The coil component according to claim 2, wherein
an angle formed between an end surface of the leg portion and the inclined surface is equal to or larger than 70 degrees and is equal to or smaller than 80 degrees.

4. The coil component according to claim 23, wherein
an intersecting portion of the inclined surface and an end surface of the leg portion is a curved surface.

5. The coil component according to claim 1, wherein
the protrusion includes a convexly-curved surface.

6. The coil component according to claim 5, wherein
the convexly-curved surface is continuous with an end surface of the leg portion.

7. An inductor comprising:
the coil component according to claim 1;
a conducting wire wound around the core; and
an electrode layer provided in each of the leg portions.

8. The coil component according to claim 3, wherein
an intersecting portion of the inclined surface and the end surface is a curved surface.
